(19) United States
(12) Patent Application Publication
(10) Pub. No.: US 2021/0308687 A1
(43) Pub. Date: Oct. 7, 2021

(54) ROTATING CUTTER DISC

(71) Applicant: GUANGDONG JIEMEI TECHNOLOGY CO., LTD., Dongguan (CN)

(72) Inventor: Xiaofeng LIANG, Dongguan (CN)

(21) Appl. No.: 17/267,506

(22) PCT Filed: Aug. 1, 2019
(86) PCT No.: PCT/CN2019/098883

§ 371 Date: Feb. 10, 2021

(30) Foreign Application Priority Data
Aug. 17, 2018 (CN) 2018109418069

(51) Int. Cl. B02C 18/18

(52) U.S. Cl. CPC B02C 18/182; E03C 1/266

(57) ABSTRACT

The present disclosure relates to a rotating cutter disc, comprising a grinding disc and an auxiliary member, wherein a grinding connecting hole is provided at a central portion of the grinding disc, the auxiliary member is mounted on the grinding disc, and an auxiliary connecting hole is provided at a central portion of the auxiliary member.

### CROSS REFERENCE TO RELATED APPLICATIONS

This application claims priority to China Patent Application No. 201810941806.9, filed on Aug. 17, 2018 before China National Intellectual Property Administration and entitled “Rotating Cutter Disc”, which is hereby incorporated by reference in its entirety.

### TECHNICAL FIELD

The present disclosure relates to the technical field of kitchen electrical equipment, and more particularly relates to a rotating cutter disc.

### BACKGROUND

With the development of the economic era, electrical equipment has become popular in every family, especially food waste disposers. It is easy to use and has been widely used in our lives. In daily lives, kitchen wastes occupy a considerable proportion of domestic wastes, such as skin melon shells and cold rice leftovers. These kitchen wastes are very easy to rot, and produce peculiar smells and breed bacteria, and can bring certain impact to both the living environment and health of families. Thus, food waste disposers rise in response to the proper time and conditions.

However, in a traditional food waste disposer, since only a connecting hole in the central portion of a rotating cutter disc is connected with an installation shaft of a driver, an acting force of the driver is concentrated on the connecting hole of the rotating cutter disc, and is not uniformly distributed to other portions of the rotating cutter disc, so that the rotating cutter disc is relatively poor in rotation balance and relatively low in force, or food wastes are only sheared for a few times on the rotating cutter disc and then are ground at the next stage. Therefore, a grinding effect on fiber and harder wastes is not ideal enough, and blockage is easy to occur.

### SUMMARY

According to various embodiments of the present disclosure, a rotating cutter disc with a good grinding effect.

A rotating cutter disc comprising a grinding disc and an auxiliary member, wherein a grinding connecting hole is provided at a central portion of the grinding disc, the auxiliary member is mounted on the grinding disc, and an auxiliary connecting hole is provided at a central portion of the auxiliary member.

Details of one or more embodiments of the present disclosure are proposed in the following accompanying drawings and descriptions. Other features, objectives and advantages of the present disclosure will become apparent from the specification, the accompany drawings and the claims.

### BRIEF DESCRIPTION OF THE DRAWINGS

In order to better describe and illustrate the embodiments and/or examples of these disclosures disclosed herein, one or more drawings may be referred. The additional details or examples used to describe the drawings should not be considered as limiting the scope of any of the disclosed disclosures, the currently described embodiments and/or examples, and the best mode of these disclosures currently understood.

FIG. 1 is a schematic diagram of a rotating cutter disc of the first embodiment;

FIG. 2 is an exploded diagram of the rotating cutter disc of FIG. 1;

FIG. 3 is a schematic diagram of a rotating cutter disc of the second embodiment;

FIG. 4 is an exploded diagram of the rotating cutter disc of FIG. 3;

FIG. 5 is a schematic diagram of a rotating cutter disc of the third embodiment;

FIG. 6 is an exploded diagram of the rotating cutter disc of FIG. 5;

FIG. 7 is a schematic diagram of a rotating cutter disc of the fourth embodiment;

FIG. 8 is an exploded diagram of the rotating cutter disc of FIG. 7;

FIG. 9 is a schematic diagram of a rotating cutter disc of the fifth embodiment;

FIG. 10 is an exploded diagram of the rotating cutter disc of FIG. 9;

FIG. 11 is a schematic diagram of a back surface of a grinding disc in the rotating cutter disc of FIG. 10.

### DESCRIPTION OF THE EMBODIMENTS

In order to facilitate understanding the present disclosure, the present disclosure will be described more comprehensively below with reference to related accompanying drawings. Preferred embodiments of the present disclosure are illustrated in the drawings. However, the present disclosure can be embodied in many different forms, and is not limited to the embodiments described herein. On the contrary, the purpose of providing these embodiments is to make the content disclosed by the present disclosure understood more thoroughly and comprehensively.

It should be noted that when an element is referred to as being “fixed” to another element, it can be directly on the other element or an intermediate element may also exist. When an element is referred to as being “connected” to another element, it can be directly connected to the other element or an intermediate element may exist at the same time.

Unless otherwise defined, all technical and scientific terms used herein have the same meanings as general understandings of those skilled in the art of the present disclosure. The terms used in the description of the present disclosure herein are merely to describe the specific embodiments, not intended to limit the present disclosure.

### Embodiment 1

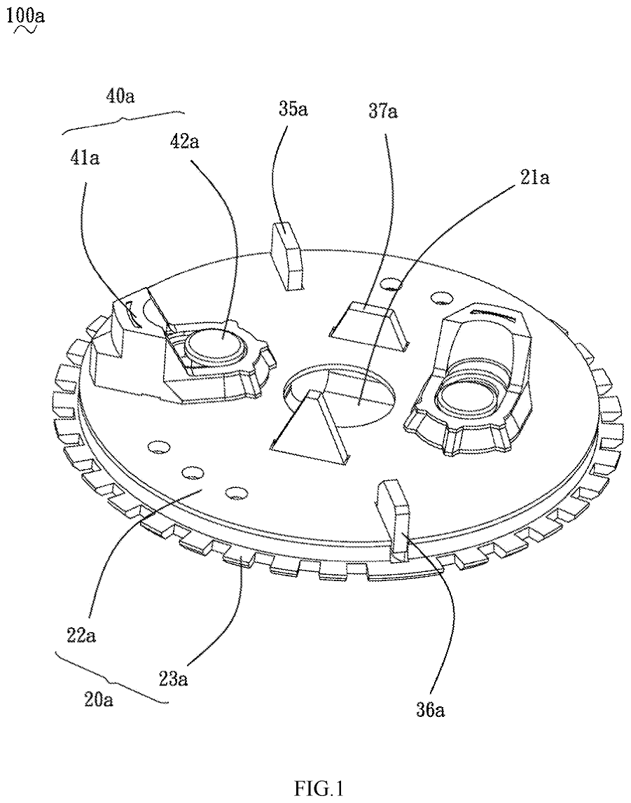

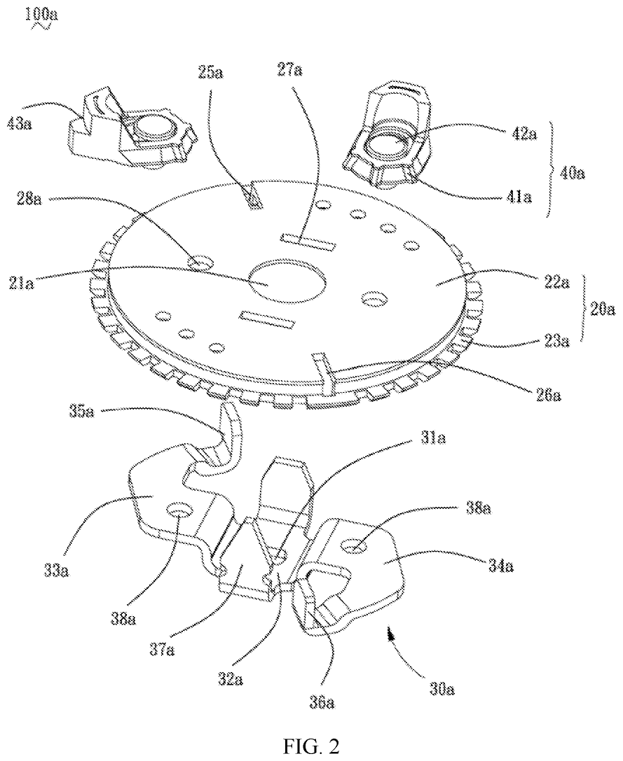

Referring to FIG. 1 and FIG. 2, a rotating cutter disc 100a of the first embodiment can be co-used with a cutter wall component, and is mainly applied to a food waste disposer. During use, the rotating cutter disc 100a is mounted in a housing of the food waste disposer.

The rotating cutter disc 100a of the present embodiment includes a grinding disc 20a and an auxiliary member 30a mounted on the grinding disc 20a. A grinding connecting hole 21a is provided at a central portion of the grinding disc 20a, and an auxiliary connecting hole 31a is provided at a central portion of the auxiliary member 30a. In the present embodiment, the rotating cutter disc 100a further includes a grinding hammer 40a movably connected to the grinding disc 20a and the auxiliary member 30a. The grinding hammer 40a can rotate on an upper surface of the grinding disc 20a to shear and push food to be disposed.

The auxiliary member 30a is mounted on the grinding disc 20a to cause a gravity center of the rotating cutter disc 100a to be concentrated at a central portion of the rotating cutter disc 100a. When the rotating cutter disc 100a rotates, a force at the central portion is better diffused outwards with a centrifugal motion to balance the rotation of the grinding disc 20a and to enable the rotation of the grinding disc 20a to be smooth and powerful, so that food wastes are hit powerfully, and a crushing effect is better. In addition, the situation that residues are hidden in gaps due to small impact force is avoided.

Specifically, the grinding disc 20a includes a disc-shaped body portion 22a and a shear portion 23a extending from a circumferential edge of the body portion 22a. The shear portion 23a includes a plurality of working teeth, and a plane where the working teeth is located is lower than a plane where the body portion 22a is located, so that the grinding disc 20a is in tight fit with the cutter wall component.

As shown in FIG. 2, the grinding connecting hole 21a is a circular hole, which is located at a central portion of the body portion 22a and can be connected to a mounting shaft having a circular cross section.

The auxiliary member 30a of the present embodiment includes a supporting portion 32a, and the first shoulder portion 33a and the second shoulder portion 34a which are respectively connected to both ends of the supporting portion 32a, and the auxiliary connecting hole 31a is located at a central portion of the supporting portion 32a. The first shoulder portion 33a and the second shoulder portion 34a each are provided with a shoulder portion through hole 38a, and positions, corresponding to two shoulder portion through holes 38a, in the grinding disc 20a are provided with two grinding through holes 28a used to connect the auxiliary member 30a to the grinding disc 20a or used to mount the grinding hammer 40a. The supporting portion 32a is sunken from a joint between the supporting portion and the first shoulder portion 33a and a joint between the supporting portion and the second shoulder portion 34a towards a direction facing away from the grinding disc 20a, so that the gravity center of the rotating cutter disc 100a is pulled to the sunken position of the supporting portion 32a. During rotation, liquid can form a whirlpool rotation, which accelerates flowing of fluid formed by food residues and the liquid in a grinding cavity and improves the grinding efficiency.

Further, the supporting portion 32a, the first shoulder portion 33a and the second shoulder portion 34a are connected to form an S shape, so that an acting force is transmitted to a larger area by means of the supporting portion 32a, the first shoulder portion 33a and the second shoulder portion 34a, and a connection between the auxiliary member 30a and the grinding disc 20a is stabler. Of course, the supporting portion 32a, the first shoulder portion 33a and the second shoulder portion 34a can also be connected to form an in-line shape, which can also stabilize the auxiliary member 30a and the grinding disc 20a. However in contrast, the acting force transmission effect of the S shape is better.

The first convex lug 35a and the second convex lug 36a are respectively provided at end portions of the first shoulder portion 33a and the second shoulder portion 34a, and the first convex lug 35a and the second convex lug 36a protrude towards the grinding disc 20a. The first lug slot 25a and the second lug slot 26a are respectively provided at positions, corresponding to the first convex lug 35a and the second convex lug 36a, of the grinding disc 20a. The first convex lug 35a and the second convex lug 36a pass through the grinding disc 20a respectively through the first lug slot 25a and the second lug slot 26a, and protrude out of the grinding disc 20a. The first convex lug 35a extends from a portion close to the central portion of the grinding disc 20a towards an edge of the grinding disc 20a to form longitudinal extending. Similarly, the second convex lug 36a also extends longitudinally. The positions of the first convex lug 35a and the second convex lug 36a are close to the edge of the grinding disc 20a, and are in relative isolation arrangement, i.e., central symmetry, so that acting forces of the first convex lug 35a and the second convex lug 36a are balanced in a rotating process. The first convex lug 35a and the second convex lug 36a are used for cooperating with the cutter wall component for shearing to enhance a shear effect. In addition, the auxiliary member 30a and the grinding disc 20a transmit an interactive acting force through the first convex lug 35a and the second convex lug 36a. Furthermore, the auxiliary member 30a is fixedly connected to the grinding disc 20a through the first convex lug 35a and the second convex lug 36a to prevent a situation that the auxiliary member 30a is separated from the grinding disc 20a in the rotating process.

Specifically, as shown in FIG. 1, one side of the first convex lug 35a protrudes from the edge of the grinding disc 20a, and one side of the second convex lug 36a protrudes from the edge of the grinding disc 20a. For fragments clamped on the cutter wall component or fragments adhered on the cutter wall component, a protrusion of the first convex lug 35a and a protrusion of the second convex lug 36a can further push these fragments, and cooperate with the cutter wall component to perform grinding, or the fragments enter the next stage of grinding through holes of the cutter wall component to improve the grinding efficiency.

The supporting portion 32a is provided with a supporting convex lug 37a which protrudes towards the grinding disc 20a. A position, corresponding to the supporting convex lug 37a, of the grinding disc 20a is provided with a supporting lug slot 27a. The supporting convex lug 37a passes through the grinding disc 20a by means of the supporting lug slot 27a, and protrudes out of the grinding disc 20a. The supporting convex lug 37a transversely extends relative to the first convex lug 35a and the second convex lug 36a, so that the connection between the auxiliary member 30a and the grinding disc 20a is reinforced; and at the same time, the supporting convex lug cooperates with the first convex lug 35a and the second convex lug 36a as well as the cutter wall component to enhance the shear effect.

The grinding hammer 40a includes a grinding seat 41a and a connecting column 42a connected to the grinding seat 41a. The grinding seat 41a is movably mounted on the auxiliary member 30a through the connecting column 42a to cause the grinding seat 41a to rotatably perform shearing on a disc surface of the grinding disc 20a. Preferably, an avoiding site 43a is provided on the grinding seat 41a to cooperatively fix shear teeth of a cutter wall to perform shearing.

The above-mentioned rotating cutter disc 100a is applied to a food waste disposer. The food waste disposer includes a housing, a driving mechanism mounted in the housing, and a rotating cutter disc 100a connected to the driving mechanism. The driving mechanism is connected to the rotating cutter disc 100a through a mounting shaft, and can drive the rotating cutter disc 100a to work. A carrying cavity is formed in the housing, and the carrying cavity is provided with an outflow port to communicate with the exterior of the housing. The carrying cavity is located below the rotating cutter disc 100a and used to carry food residues disposed by the rotating cutter disc 100a. The food residues are then discharged out of the housing through the outflow port to complete food waste disposal.

In the above-mentioned rotating cutter disc 100a, the auxiliary member 30a is used to cooperate with the grinding disc 20a to enhance the shear effect of the rotating cutter disc 100a, and various types of mounting shafts may be connected by means of the grinding connecting hole 21a and the auxiliary connecting hole 31a, so that the use flexibility is improved, and the adaptability is high.

### Embodiment 2

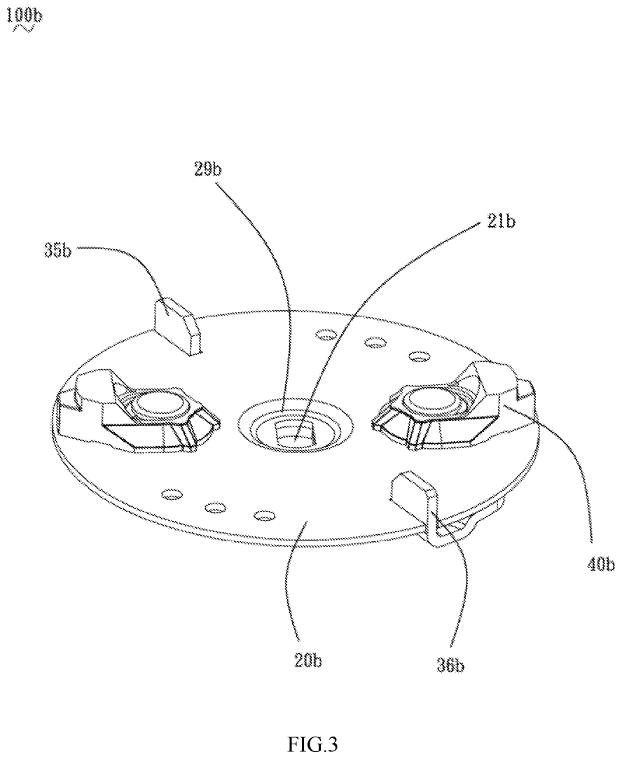

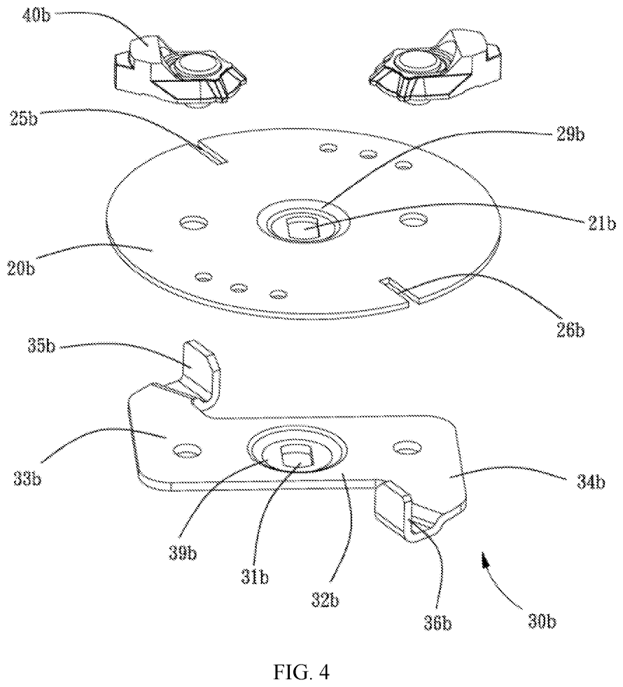

Referring to FIG. 3 and FIG. 4, a rotating cutter disc 100b of the second embodiment includes a grinding disc 20b, and an auxiliary member 30b and a grinding hammer 40b which are mounted on the grinding disc 20b. A grinding connecting hole 21b is provided at a central portion of the grinding disc 20b, and an auxiliary connecting hole 31b is provided at a central portion of the auxiliary member 30b.

As shown in FIG. 4, a difference between the grinding disc 20b of the present embodiment and the grinding disc 20a of Embodiment 1 is that: the grinding disc 20b is disc-shaped; an edge of the grinding disc 20b is not provided with the shear portion 23a; a grinding mounting site 29b is provided at the central portion of the grinding disc 20b; and the grinding connecting hole 21b is a waist-shaped hole.

Specifically, the grinding connecting hole 21b is located at a central portion of the grinding mounting site 29b; and the grinding mounting site 29b protrudes towards the auxiliary member 30b, and a surface thereof away from the auxiliary member 30b is of an inwards sunken structure used to stabilize a mounting shaft connected to a food waste disposer. Preferably, the sunken structure of the grinding mounting site 29b is sunken like steps.

The grinding connecting hole 21b is a waist-shaped hole which can be connected to various types of mounting shafts to improve the use flexibility. For example, the grinding connecting hole 21b which is a waist-shaped hole can be connected to a mounting shaft having a waist-shaped section to prevent the connection between the grinding disc 20b and the mounting shaft from being loosened in a rotating process to affect normal use of the food waste disposer. The grinding connecting hole 21b of a waist-shaped hole structure can also be connected to mounting shafts of other shapes, such as a cylindrical mounting shaft having a diameter equal to a length of a short axis of the waist-shaped hole, to improve the use flexibility.

A difference between the auxiliary member 30b of the present embodiment and the auxiliary member 30a of Embodiment 1 is that: a connection portion between a supporting portion 32b and the first shoulder portion 33b and a connection portion between the supporting portion 32b and the second shoulder portion 34b are flat; the supporting portion 32b is not provided with the supporting convex lug 37a; and an auxiliary mounting site 39b is provided at the central portion of the auxiliary member 30b.

Specifically, the connection portion between the supporting portion 32b and the first shoulder portion 33b and the connection portion between the supporting portion 32b and the second shoulder portion 34b are of a flat S shape. The flat portions are in tight fit with the grinding disc 20b to balance the rotation of the rotating cutter disc 100b and to prevent a situation that the auxiliary member 30b is separated from the grinding disc 20b in the rotating process.

The auxiliary member 30b is provided with the auxiliary mounting site 39b; the auxiliary connecting hole 31b is located at a central portion of the auxiliary mounting site 39b; and a position of the auxiliary mounting site 39b corresponds to a position of the grinding mounting site 29b. The auxiliary mounting site 39b protrudes towards a direction facing away from the grinding disc 20b, and a surface, close to the grinding disc 20b, of the auxiliary mounting site is of an inwards sunken structure. The sunken structure of the auxiliary mounting site 39b is sunken like steps, and is matched with the sunken structure of the grinding mounting site 29b. In this way, the auxiliary mounting site 39b can wrap the protrusion of the grinding mounting site 29b to enable the auxiliary member 30b to be in tight connection with the grinding disc 20b.

The auxiliary connecting hole 31b is a waist-shaped hole which can be connected to various types of mounting shafts to improve the use flexibility. For example, the auxiliary connecting hole 31b which is a waist-shaped hole can be connected to a mounting shaft having a waist-shaped section to prevent the connection between the auxiliary member 30b and the mounting shaft from being loosened in a rotating process to affect normal use of the food waste disposer. The auxiliary connecting hole 31b of a waist-shaped hole structure can also be connected to mounting shafts of other shapes, such as a cylindrical mounting shaft having a diameter equal to a length of a short axis of the waist-shaped hole.

The rotating cutter disc 100b of the present embodiment can be applied to a direct-current type food waste disposer. The auxiliary member 30b is co-used with the grinding disc 20b to facilitate balancing the acting force in the rotating process, i.e., balancing the rotation of the rotating cutter disc 100b, so that shearing and grinding are more powerful, the grinding effect is better, and the overall crushing effect is improved. The grinding disc 20b and the auxiliary member 30b are respectively provided with the waist-shaped grinding connecting hole 21b and the auxiliary connecting hole 31b, and various types of mounting shafts may be connected by means of the grinding connecting hole 21b and the auxiliary connecting hole 31b, so that the use flexibility is improved, and the adaptability is high.

### Embodiment 3

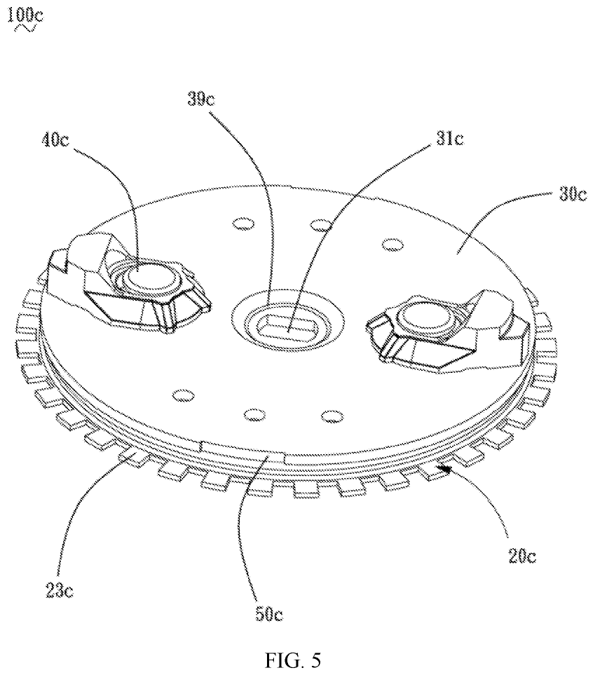

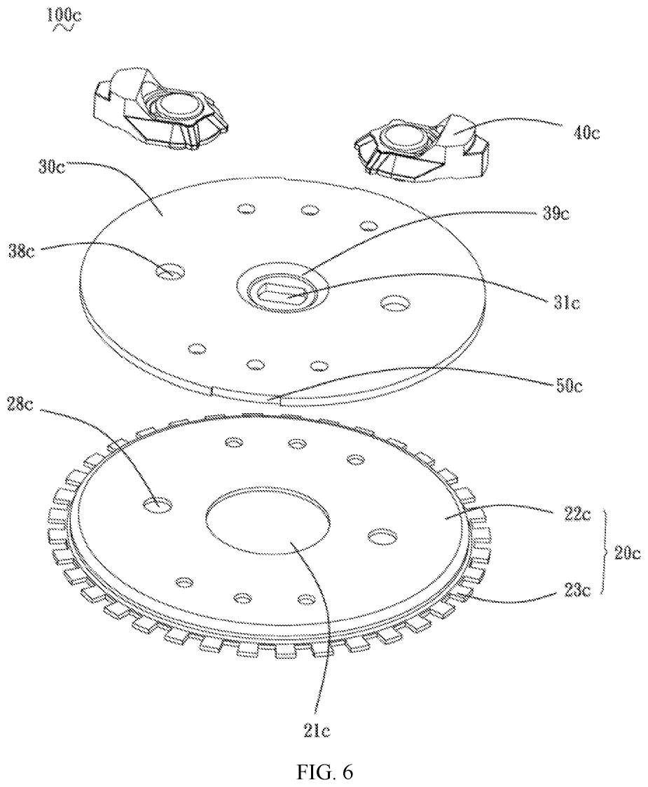

Referring to FIG. 5 and FIG. 6, a rotating cutter disc 100c of the third embodiment includes a grinding disc 20c, and an auxiliary member 30c and a grinding hammer 40c which are mounted on the grinding disc 20c. A grinding connecting hole 21c is provided at a central portion of the grinding disc 20c, and an auxiliary connecting hole 31c is provided at a central portion of the auxiliary member 30c.

As shown in FIG. 6, a difference between the grinding disc 20c of the present embodiment and the grinding disc 20a of Embodiment 1 is that: a body portion 22c of the grinding disc 20c is not provided with the first lug slot 25a, the second lug slot 26a and the supporting lug slot 27a.

The auxiliary member 30c of the present embodiment is disc-shaped, is mounted above the grinding disc 20c, and has a diameter greater than that of the body portion 22c of the grinding disc 20c. Specifically, the auxiliary member 30c has a diameter greater than that of the body portion 22c of the grinding disc 20c and less than that of a plane where a shear portion 23c is located, that is, the diameter of the auxiliary member 30c is between the diameter of the body portion 22c of the grinding disc 20c and the diameter of the plane where the shear portion 23c is located. An annular slot is provided between the auxiliary member 30c and working teeth of the shear portion 23c, so that the grinding effect of food wastes on the grinding disc 20c is better.

An auxiliary through hole 28c is provided at a position, corresponding to a grinding through hole 38c, in the auxiliary member 30c, and is used to mount the grinding hammer 40c.

An auxiliary mounting site 39c is provided at the central portion of the auxiliary member 30c, and the auxiliary mounting site 39c protrudes towards the grinding disc 20c, and a surface, away from the grinding disc 20c, of the auxiliary mounting site is of an inwards sunken structure. The sunken structure of the auxiliary mounting site 39c is sunken like steps. A shaft cap of a mounting shaft may be in tight connection to the sunken structure of the auxiliary mounting site 39c to reduce the situation that residues are hidden in gaps between the shaft cap and the auxiliary member 30c. The auxiliary connecting hole 31c is located at a central portion of the auxiliary mounting site 39c; and the auxiliary connecting hole 31c is a waist-shaped hole which can be connected to various types of mounting shafts to improve the use flexibility.

Specifically, a plurality of notches 50c which are disposed at intervals are provided at a circumferential edge of the auxiliary member 30c; inflow regions are formed in clearances between the notches 50c and the adjacent shear portion 23c on the grinding disc 20c, and are used to allow food wastes on the auxiliary member 30c to flow into the shear portion 23c of the grinding disc 20c for shearing. Preferably, the diameter of a circle where inner side edges of the notches 50c is greater than the diameter of the body portion 22c. In some cases, when the waste disposer performs first-stage grinding on kitchen wastes, i.e., first-stage grinding realized through cooperation between the rotation of the grinding disc 20c and a cutter wall component, since harder kitchen wastes such as bones are subjected to the first-stage grinding, larger particles will be produced, the diameter of which is greater than a distance between the edge of the grinding disc 20c and the cutter wall component. With the rotation of a motor, larger particles will be clamped on the edges of the cutter wall component and the rotating cutter disc 100c, and cannot fall off from the clearance between the edges of the cutter wall component and the rotating cutter disc 100c, resulting in problems of downtime and idling of the rotating cutter disc 100c. The design of the notches can enable these larger particles to flow to the next stage of grinding, thereby avoiding the problems of downtime and idling of the rotating cutter disc 100c.

There are two notches 50c of the present embodiment, which are oppositely disposed at an interval, and larger particulate disintegrating slag can flow to the next stage of grinding in two directions. Of course, there may also be three, four, five or more notches 50c, which will be decided according to rotation balance of the auxiliary member 30c and cooperation between the auxiliary member 30c and the grinding disc 20c.

In the above-mentioned rotating cutter disc 100c, the auxiliary member 30c is used to cooperate with the grinding disc 20c; the auxiliary member 30c has a flow limiting effect on the food wastes flowing into the grinding disc 20c, so that the food wastes can flow into the position of the grinding disc 20c for next stage of grinding after being subjected to multiple shearing, thereby greatly reducing the situation that fiber wastes block a pipeline after being sheared; the grinding effect is better, and the overall smashing efficiency is improved; and furthermore, various types of mounting shafts may be connected by means of the grinding connecting hole 21c and the auxiliary connecting hole 31c, so that the use flexibility is improved, and the adaptability is high.

### Embodiment 4

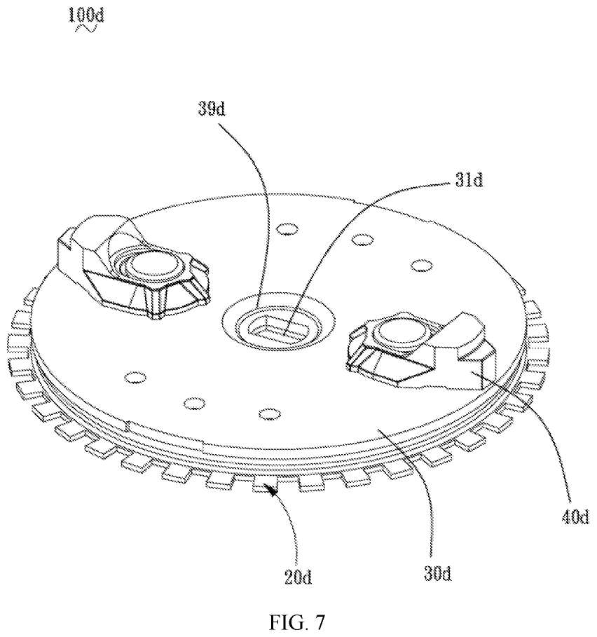

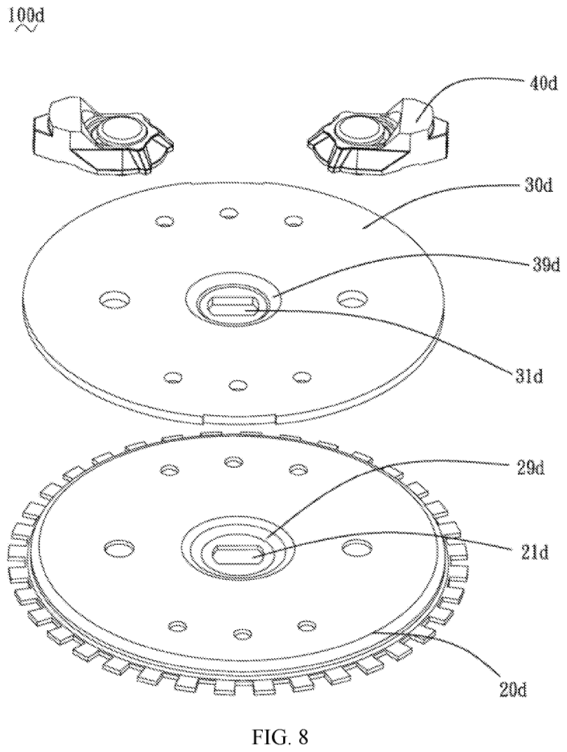

Referring to FIG. 7 and FIG. 8, a rotating cutter disc 100d of the fourth embodiment includes a grinding disc 20d, and an auxiliary member 30d and a grinding hammer 40d which are mounted on the grinding disc 20d. A grinding connecting hole 21d is provided at a central portion of the grinding disc 20d, and an auxiliary connecting hole 31d is provided at a central portion of the auxiliary member 30d.

The structure of the auxiliary member 30d of the present embodiment is the same as the structure of the auxiliary member 30c of Embodiment 3, so repeated descriptions are omitted here.

As shown in FIG. 8, a difference between the grinding disc 20d of the present embodiment and the grinding disc 20c of Embodiment 3 is that: the grinding connecting hole 21d is a waist-shaped hole, and the grinding disc 20d is provided with a grinding mounting site 29d.

Specifically, a position, corresponding to an auxiliary mounting site 39d, in the grinding disc 20d is provided with the grinding mounting site 29d. The grinding connecting hole 31d is located at a central portion of the grinding mounting site 29d, and is used to connect a mounting shaft of a food waste disposer to drive the grinding disc 20d and the auxiliary member 30d to rotate and provide power for food wastes poured onto the auxiliary member 30d to rotate.

The grinding mounting site 29d protrudes towards a direction facing away from the auxiliary member 30d, and a surface, close to the auxiliary member 30d, of the grinding mounting site is of a sunken structure. The auxiliary mounting site 39d protrudes towards the grinding disc 20d, and a surface, away from the grinding disc 20d, of the auxiliary mounting site is of a sunken structure. In this way, the grinding mounting site 29d may wrap the protrusion of the auxiliary mounting site 39d, so that the grinding disc 20d is in tight connection with the auxiliary member 30d.

In the above-mentioned grinding component 100d, the auxiliary member 30d is used to cooperate with the grinding disc 20d; the auxiliary member 30d has a flow limiting effect on the food wastes flowing into the grinding disc 20d, so that the food wastes can flow into the position of the grinding disc 20d for next stage of grinding after being subjected to multiple shearing, thereby greatly reducing the situation that fiber wastes block a pipeline after being sheared; the grinding effect is better, and the overall smashing efficiency is improved; and furthermore, various types of mounting shafts may be connected by means of the grinding connecting hole 21d and the auxiliary connecting hole 31d, so that the use flexibility is improved, and the adaptability is high.

### Embodiment 5

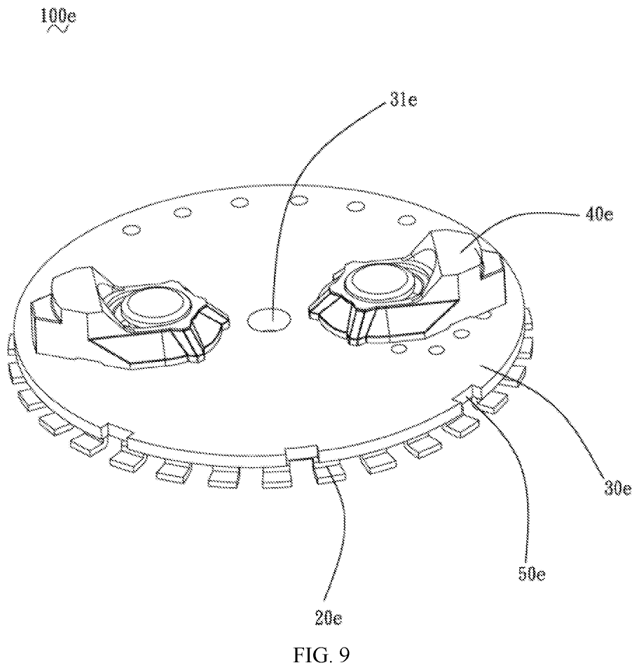

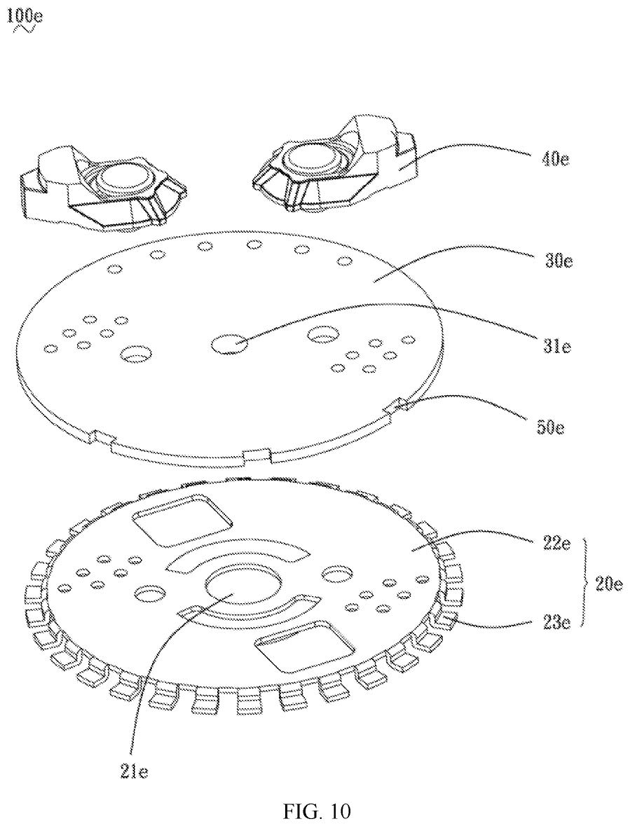

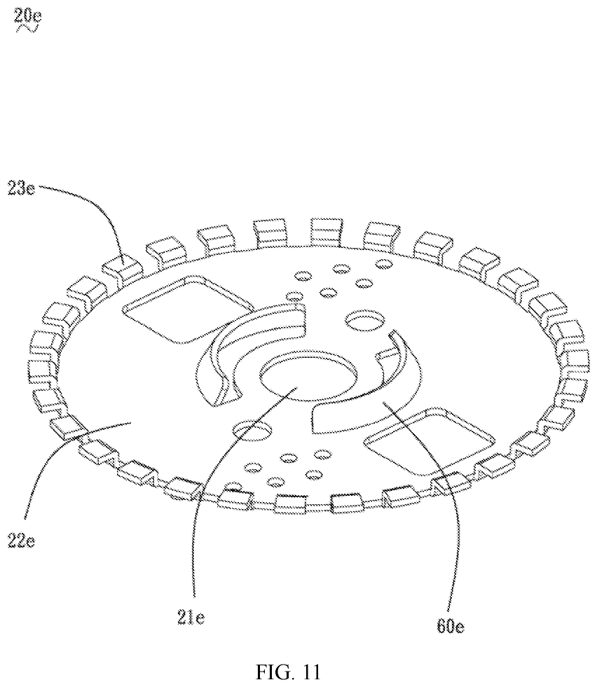

Referring to FIG. 9 to FIG. 11, a rotating cutter disc 100e of the fifth embodiment includes a grinding disc 20e, and an auxiliary member 30e and a grinding hammer 40e which are mounted on the grinding disc 20e. A grinding connecting hole 21e is provided at a central portion of the grinding disc 20e, and an auxiliary connecting hole 31e is provided at a central portion of the auxiliary member 30e.

The grinding disc 20e of the present embodiment includes a disc-shaped body portion 22e and a shear portion 23e extending from a circumferential edge of the body portion 22e. The shear portion 23e includes a plurality of working teeth, and the working teeth are formed by downwards bending the shear portion 23e, i.e., a plane where the working teeth is located is lower than a plane where the body portion 22e is located, so that the grinding disc 20e is in tight fit with a cutter wall component. A stop block 60e is provided at a back surface of the body portion 22e, and the stop block 60e is located at a periphery close to the grinding connecting hole 21e. The stop block 60e is approximately of a semi-arc shape, and is formed by outwards flanging the body portion 22e. There are two stop blocks 60e, which are mainly used to protect a mounting shaft.

A difference between the auxiliary member 30e of the present embodiment and the auxiliary member 30c of Embodiment 3 is that: the distribution of notches 50e is different, and the auxiliary connecting hole 31e is a circular hole.

Specifically, three notches 50e are provided at an edge of the auxiliary member 30e; the three notches 50e are distributed on the same semicircle. This semicircle is a semicircle divided by taking the same diameter line, where a circle center of a grinding through hole 28e and a circle center of the auxiliary connecting hole 31e are located, as a division line. Larger particulate disintegrating slag can continuously fall to the next stage of grinding in the same semicircle for centralized disposal.

The auxiliary connecting hole 31e is a circular hole, and has a diameter less than that of the grinding connecting hole 21e, so that a connection between the auxiliary connecting hole 31e and the mounting shaft is tighter.

It can be understood that the auxiliary member 30a of Embodiment 1 can replace the auxiliary member of Embodiment 2, that is, the auxiliary member 30a of Embodiment 1 can be co-used with the grinding disc 20b of Embodiment 2, and the grinding disc 20a of Embodiment 1 can be co-used with the auxiliary member 30b of Embodiment 2. The auxiliary member 30c of Embodiment 3 or the auxiliary member 30d of Embodiment 4 replaces the auxiliary member of Embodiment 5, that is, the auxiliary member 30c of Embodiment 3 can be co-used with the grinding disc 20e of Embodiment 5, and the grinding disc 20c of Embodiment 3 or the grinding disc 20d of Embodiment 4 can be co-used with the auxiliary member 30e of Embodiment 5. This can also achieve the effects of improved overall smashing efficiency and good use flexibility.

The above-mentioned embodiments only express several implementation modes of the present disclosure, and their descriptions are more specific and detailed, but they cannot be understood as limiting the patent scope of the present disclosure. It should be noted that those of ordinary skill in the art can further make various transformations and improvements without departing from the concept of the present disclosure, and these transformations and improvements all fall within the protection scope of the present disclosure. Therefore, the protection scope of the patent of the present disclosure shall be subject to the appended claims.

1. A rotating cutter disc comprising a grinding disc and an auxiliary member mounted on the grinding disc, wherein a grinding connecting hole is provided at a central portion of the grinding disc, an auxiliary connecting hole is provided at a central portion of the auxiliary member, the auxiliary member is provided with the auxiliary mounting site, and the auxiliary connecting hole is located at a central portion of the auxiliary mounting site.

2. The rotating cutter disc of claim 1, wherein the grinding disc is disc-shaped.

3. The rotating cutter disc of claim 1, wherein the grinding disc comprises a body portion and a shear portion extending from a circumferential edge of the body portion, and the shear portion comprises a plurality of working teeth.

4. The rotating cutter disc of claim 3, wherein a stop block is provided at a back surface of the body portion, and the stop block is located at a periphery close to the grinding connecting hole.

5. The rotating cutter disc of claim 1, wherein a grinding mounting site is provided at a position, corresponding to a position of the auxiliary mounting site, of the central portion of the grinding disc, and the grinding connecting hole is located at a central portion of the grinding mounting site.

6. The rotating cutter disc of claim 5, wherein the grinding mounting site protrudes towards a direction facing away from the auxiliary member, and a surface, close to the auxiliary member, of the grinding mounting site is of a sunken structure.

7. The rotating cutter disc of claim 6, wherein the sunken structure of the grinding mounting site is sunken like steps.

8. The rotating cutter disc of claim 1, wherein the grinding connecting hole is a circular hole or a waist-shaped hole.

9. (canceled)

10. The rotating cutter disc of claim 1, wherein the auxiliary member comprises a supporting portion, a first shoulder portion and a second shoulder portion which are respectively connected to both ends of the supporting portion, the auxiliary connecting hole is located at a central portion of the supporting portion, and the first shoulder portion and the second shoulder portion are respectively connected with the grinding disc.

11. The rotating cutter disc of claim 10, wherein a first convex lug and a second convex lug are respectively provided at end portions of the first shoulder portion and the second shoulder portion, and the first convex lug and the second convex lug protrude towards the grinding disc; a first lug slot and a second lug slot are respectively provided at positions, corresponding to the first convex lug and the second convex lug, of the grinding disc, the first convex lug and the second convex lug pass through the grinding disc respectively through the first lug slot and the second lug slot, and protrude out of the grinding disc.

12. The rotating cutter disc of claim 11, wherein one side of the first convex lug protrudes from an edge of the grinding disc, and one side of the second convex lug protrudes from the edge of the grinding disc.

13. The rotating cutter disc of claim 10, wherein the supporting portion is provided with a supporting convex lug which protrudes towards the grinding disc; a position, corresponding to the supporting convex lug, of the grinding disc is provided with a supporting lug slot, the supporting convex lug passes through the grinding disc through the supporting lug slot, and protrudes out of the grinding disc.

14. The rotating cutter disc of claim 13, wherein the supporting portion is sunken from a joint between the supporting portion and the first shoulder portion and a joint between the supporting portion and the second shoulder portion towards a direction facing away from the grinding disc.

15. The rotating cutter disc of claim 10, wherein the supporting portion, the first shoulder portion and the second shoulder portion are connected to form an S shape.

16. The rotating cutter disc of claim 1, wherein the auxiliary member is disc-shaped and provided with at least one notch.

17. (canceled)

18. The rotating cutter disc of claim 16, wherein the auxiliary mounting site protrudes towards a direction facing away from the grinding disc, and a surface, close to the grinding disc, of the auxiliary mounting site is of an inwards sunken structure.

19. The rotating cutter disc of claim 16, wherein the auxiliary mounting site protrudes towards the grinding disc, and a surface, away from the grinding disc, of the auxiliary mounting site is of an inwards sunken structure.

20. The rotating cutter disc of claim 18, wherein the sunken structure of the auxiliary mounting site is sunken like steps.

21. The rotating cutter disc of claim 1, wherein the auxiliary connecting hole is a circular hole or a waist-shaped hole.

22. The rotating cutter disc of claim 1, wherein the rotating cutter disc further comprises a grinding hammer connected to the grinding disc and the auxiliary member, the grinding hammer comprises a grinding seat and a connecting column connected to the grinding seat, and the grinding seat is movably mounted on the auxiliary member through the connecting column.
